(19) United States
(12) Patent Application Publication
(10) Pub. No.: US 2002/0133302 A1
(43) Pub. Date: Sep. 19, 2002

(54) Environmental performance improvement support system and environmental performance improvement support method

(75) Inventors: Tetsuya Matsui, Hitachi (JP); Kiyomi Funabashi, Hitachinaka (JP); Yoshiaki Ichikawa, Naka-gun (JP); Takako Oono, Hitachinaka (JP); Akira Sekine, Hitachiohta (JP)

Correspondence Address: Crowell & Moring LLP, The Evenson, McKeown, Edwards & Lenahan, Intellectual Property Law Gr., 1001 Pennsylvania Avenue, N.W., Washington, DC, 20004-2595, US

(73) Assignee: Hitachi, Ltd.

(21) Appl. No.: 10/053,697

(22) Filed: Jan. 24, 2002

(30) Foreign Application Priority Data
Mar. 15, 2001 (JP) 2001-73349

(51) Int. Cl. G06F 17/60

(52) U.S. Cl. 702/30; 700/266; 705/1

(57) ABSTRACT

The problem is providing an environmental performance improvement support system and an environmental performance improvement support method that support to improve effects on the environment due to release of chemical substances.

Environmental performance improvement support system 1 that sets the release amounts to each release-transfer destination of chemical substances that make up these materials based on the types and input amounts of the materials that are input in a certain process, and also sets information for improving the environmental performance according to information on these chemical substances that are released, wherein release rate-related information is set, based on release information that prescribes the relationship of the release amounts to each release-transfer destination of the chemical substances with respect to the input amounts of the materials that are input into an equipment that is used in a certain process, and environmental performance information that evaluates environmental effects due to discharging the chemical substances in the release amounts that correspond to the input amounts of the materials that are input, and/or investment effectiveness information related to the costs for reducing the chemical substances that are released are set.

### BACKGROUND OF THE INVENTION

1. Field of the Invention

The present invention relates to an environmental performance improvement support system that supports improvement of effects on the environment due to discharging chemical substances and to an environmental performance improvement support method.

2. Description of Related Art

The various materials that are currently being distributed include several hundred types of the chemical substances that are controlled because they have large effects on the environment (hereinafter called controlled substances). Because of this, when an enterpriser handles in processes such as the manufacture, distribution, or storage of such materials, it is necessary to investigate how much of the controlled substances that compose those materials is being transferred, how much is being released into the air, soil, or water areas, or is being circulated in the market as part of shipped products.

Accordingly, a legal system called the “Law Concerning Reporting, etc. of Releases to the Environment of Specific Chemical Substances and Promoting Improvements in their Management,” (Law No. 86 of 1999(Japan). Promulgated on Jul. 13, 1999), hereinafter called the “PRTR Law,” which estimates the effects to the environment of the entire country by having enterprisers report quantitative data on the release and transfer of controlled substances at the business establishment to the national and local governments, was started.

For dealing with this PRTR Law, a system that enables an enterpriser to totalize quantitative data on the release and transfer of controlled substances at the business establishment has been put into practice. This system allows basic data on controlled substances to be input for each department or process and has functions that collect and totalize the results in a higher organizational (business establishment, company, etc.) unit. Only these totalized results are necessary as compliance documents for the PRTR Law. This system is described, for example, on pages 37 to 40 of Issue 8, Volume 82, of the “Hitachi Hyoron” (issued in August 2000).

### SUMMARY OF THE INVENTION

When controlled substances that make up materials being handled in processes such as manufacturing, distribution, and storage, and the like, are released into the air, soil, or water areas, the environment around the areas where the substances are released becomes worse. However, since said system focused mainly on the calculation and totalization of release and transfer amounts of controlled substances, the functions for improving the environmental performance based on these totalized results were inadequate. Furthermore, in said system, the functions that supported risk communication to residents around the controlled substance release areas, based on the totalized results of the release and transfer amounts, were inadequate, too. Here, environmental performance is degree of the load on the environment (effect on the environment). Also, risk communication is the explanation, disclosure, and communication of information regarding the effect on the environment (particularly, degree of danger).

Accordingly, the objective of the present invention is to provide an environmental performance improvement support system and an environmental performance improvement support method that support improvement of the environmental effects caused by the release of chemical substances.

Based on a material composition database that organizes composition information for materials as a database, a controlled substance database that organizes control information related to controlled chemical substances as a database, and a release rate database that organizes information related to the release rates at each release-transfer destination of chemical substances as a database, and based on the types and input amounts of the materials that are input in a certain process, the present invention, which realizes said object, sets the release amounts to each release-transfer destination of chemical substances that compose said materials, and supports improvement of the environmental performance, according to this chemical substance information that has been set. For this, paying attention to the fact that the release amounts to each release-transfer destination of the chemical substances depend on an equipment that releases the chemical substances, the present invention sets data related to release rates, based on information that prescribes the relationship between the input amounts of the materials that are input into an equipment that is used in a certain process and the release amounts to each release-transfer destination of the chemical substances. Furthermore, for the chemical substances in the release amounts that are set based on data related to the release rates associated with an equipment, the present invention sets environmental performance information that evaluates the effects that those chemical substances have on the environment and/or investment effectiveness information related to the cost for reducing those chemical substances.

### BRIEF DESCRIPTION OF THE DRAWINGS

FIG. 1 is a configuration drawing of the environmental performance improvement support system that is related to the present preferred embodiment.

FIG. 2 is an example of the data structure of some of the databases in FIG. 1, where (a) is the material composition database, (b) is the controlled substance database, (c) is the chemical substance property database, (d) is the MSDS database, and (e) is the release rate database.

FIG. 3 is a conceptual diagram for explaining the emission scenario documents (ESD) that are related to the present preferred embodiment.

FIG. 4 is a concrete example of the emission scenario document (ESD) information that is related to the present preferred embodiment, where (a) is a graph format, (b) is a numerical value table format, and (c) is a functional equation format.

FIG. 5 is a conceptual diagram that shows an example of the relationship of the equipment-specific emission scenario document (ESD) information that is related to the present preferred embodiment and the manufacturing process.

FIG. 6 is an example of a process diagram for the cleaning process that is performed by the user company that is related to the present preferred embodiment.

FIG. 7 is an evaluation table that shows an example of the environmental effect evaluation results in the user company that performs the cleaning process of FIG. 6.

FIG. 8 is a comparison table that shows an example of the comparison results for evaluation of PFC gas treatment equipments that are related to the present preferred embodiment.

FIG. 9 shows comparison diagrams that compare PFC gas-related information between the user company and other companies in the same industry in the case of PFC gas treatment equipments that are related to the present preferred embodiment are introduced, where (a) is a comparison diagram with handled amounts and release amounts of PFC gas, and (b) is a comparison diagram with handled amounts and release rates of PFC gas.

FIG. 10 is a flow diagram that shows the flow of information, services, and money among the ASP enterpriser (environmental performance improvement support system), user company, and equipment manufacturer that are related to the present preferred embodiment.

FIG. 11 is a flow chart that shows the environmental performance improvement support method that is related to the present preferred embodiment.

### DESCRIPTION OF THE PREFERRED EMBODIMENTS

Below, referring to figures, the preferred embodiment of the environmental performance improvement support system and environmental performance improvement support method related to the present invention is explained.

The environmental performance improvement support system that is related to the present invention has a material composition database that organizes composition information for materials as a database, a controlled substance database that organizes control information related to controlled chemical substances as a database, and a release rate database that organizes information related to the release rates at each release-transfer destination of chemical substances as a database, and sets the release rates at each release-transfer destination of chemical substances that compose input materials, based on the types and input amounts of the materials that are input in a certain process, and also sets information for improving the environmental performance, according to information on the chemical substances that are released.

For this, because the release amounts to each release-transfer destination of chemical substances depend on an equipment (for example, combustion equipment, painting equipment, metal plating equipment, storage equipment, etc.) into which the materials that contain those chemical substances are input, this environmental performance improvement support system sets highly accurate data related to release rates by using emission scenario document (hereinafter referred to as ESD [emission scenario document]) information that shows the relationship between the materials that are input into an equipment used in a certain process and the chemical substances that are released. This ESD information prescribes the relationship of the release amounts to each release-transfer destination of the chemical substances that are released, with respect to the input amounts of the materials that are input into an equipment that is used in a certain process. For each equipment, this relationship is prescribed in graph format, table format, with functional equations, or with a combination of these formats. Furthermore, the equipments that are used in this certain process includes a combination of a plurality of equipments.

In the present preferred embodiment, the ESD information corresponds to the release information that is described in What Is Claimed Is.

Furthermore, to improve the environmental performance, this environmental performance improvement support system sets environmental performance information that evaluates the effects on the environment of the chemical substances that are released in the release amounts are set based on the equipment-specific ESD information. This environmental performance information is information that evaluates environmental effects based on at least one impact factor from among impact factors on human health, impact factors on amenities, impact factors on ground subsidence, impact factors on underground water pollution and soil pollution, impact factors on air pollution, impact factors on water quality pollution, impact factors on stress on waste treatment capacity, impact factors on acid precipitation, impact factors on global warming, impact factors on ozone layer destruction, and impact factors on resource depletion. If a plurality of equipments are used in a certain process, the environmental performance information can also be set based on a combination of the plurality of equipments.

Also, to improve the environmental performance, this environmental performance improvement support system sets investment effectiveness information related to the cost for reducing the release amounts of chemical substances. This investment effectiveness information is information that is set based on at least one item from among the processing performances, equipment costs and operation costs of equipments that reduce released chemical substances. If a plurality of equipments are used in a certain process, the investment effectiveness information can also be set based on a combination of the plurality of equipments.

Also, to support risk communication, this environmental performance improvement support system provides information related to the release rates of chemical substances at the business establishment of an enterpriser who performs a certain process, or comparative information related to the chemical substance release rates of that enterpriser and another enterpriser in the same industry. For this, this environmental performance improvement support system has at least one information type from among the handled amount, release amount, release rate and recycle rate of each chemical substance, as information related to the release rates of another enterpriser in the same industry, and outputs information that compares information related to the release rates of an enterpriser and another enterpriser in the same industry, both of whom perform a certain process. In addition, this environmental performance improvement support system outputs time-lapse changes of at least one information type from among the handled amount, release amount, release rate and recycle rate of each chemical substance, as information related to the release rates of an enterpriser. Furthermore, this environmental performance improvement support system has information on the time-lapse changes for at least one information type from among the handled amount, release amount, release rate and recycle rate of each chemical substance of another enterpriser in the same industry, and outputs information that compares the time-lapse changes for at least one information type from among the handled amount, release amount, release rate, and recycle rate of each chemical substance between an enterpriser and another enterpriser in the same industry.

Also, this environmental performance improvement support system uses equipment-specific release rate information provided by the enterpriser who manufactures an equipment used in a certain process, as equipment-specific ESD information for setting information related to release rates. The equipment-specific release rate information provided by this enterpriser is release information that prescribes the relationship between the release amounts to each release-transfer destination of the chemical substances that are released and the input amounts of the materials that are input into the equipment. Furthermore, as investment effectiveness information, this environmental performance improvement support system uses information that is set based on at least one information item from among the processing performance, equipment cost, and operation cost of an equipment that reduces the released chemical substances, which is provided by the enterpriser who manufactures the equipment that is used in a certain process.

The environmental performance improvement support method related to the present invention supports environmental performance improvement based on a material composition database that organizes composition information of materials as a database, a controlled substance database that organizes control information related to controlled chemical substances as a database, and a release rate database that organizes information related to the release rates at each release-transfer destination of chemical substances as a database.

For this, this environmental performance improvement support method specifies, based on the material composition database, the chemical substances that compose the materials to be input in a certain process, and furthermore specifies the chemical substances that must be managed among the chemical substances specified based on the controlled substance database, and then sets the release amounts to the release-transfer destinations of the chemical substances that must be managed based on the release rate database. And, to improve the environmental performance, this environmental performance improvement support method evaluates the environmental effects caused by the chemical substances being released in the release amounts that have been set, and furthermore evaluates an equipment that reduces the chemical substances whose effects on the environment are judged as large from these evaluation results. Also, to support improvement in risk communication, this environmental performance improvement support method evaluates the environmental effects when the chemical substance-reducing equipment that is determined from the equipment evaluation results is introduced.

Materials are, for example, raw materials, partially finished products, finished products, and purchased goods, which are input in a certain process and include chemical substances. The release rate represents the release amount with respect to the handled amount of a chemical substance as a percentage (%). Also, the data related to release rates is the release rates themselves of chemical substances and/or data for calculating the release rates, and the data for calculating release rates includes the handled amounts, release amounts, recycle rates, etc. of chemical substances. The certain process is processes in which materials that include chemical substances are input, and for example, includes a manufacturing process, storage process, decomposition process, etc. The release-transfer destination is destinations to which the chemical substances that are released from the certain process transfer, and for example, includes the atmosphere, water regions, the soil, consumption, waste, recycling, product content, etc. The equipment that reduces chemical substances is a treatment equipment that treats the chemical substances that are released from the certain process and reduces the chemical substances, or the equipment that releases a lower amount of the chemical substances than the other equipments among equipments that can be used in the certain process.

The environmental performance improvement support system related to the present preferred embodiment is connected to, through the Internet, the communication terminals of a user company that performs manufacturing with a manufacturing system and a user company that performs cleaning with a cleaning process, etc., and the communication terminals of the equipment manufacturer that manufactures an equipment being used in a certain system and the equipment manufacturer that manufactures a treatment equipment that reduces a chemical substance, etc. And, this environmental performance improvement support system is operated by an application service provider (hereinafter referred to as ASP [Application Service Provider]). This ASP enterpriser provides services related to environmental performance improvement support. In the present preferred embodiment, the environmental performance improvement support system is configured so that the environmental performance improvement support is performed by executing an environmental performance improvement support program with an electronic computer, by loading or installing the environmental performance improvement support program that has been stored on a storage medium (CD-ROM, etc.) or the environmental performance improvement support program that is delivered through the network (the Internet, etc.), on an electronic computer such as a personal computer, or by using directly the environmental performance improvement support system on the server of an ASP enterpriser, through the Internet, etc.

With the present preferred embodiment, a user company corresponds to the enterpriser who performs a certain process, as described in What Is Claimed Is, the equipment manufacturer that manufactures an equipment used in a certain system corresponds to the enterpriser who manufactures an equipment used in a certain process, as described in What Is Claimed Is, and the equipment manufacturer that manufactures an equipment used in a certain system and the equipment manufacturer that manufactures a treatment equipment that reduces a chemical substance correspond to the enterpriser who manufactures an equipment that reduces a chemical substance, as described in What Is Claimed Is.

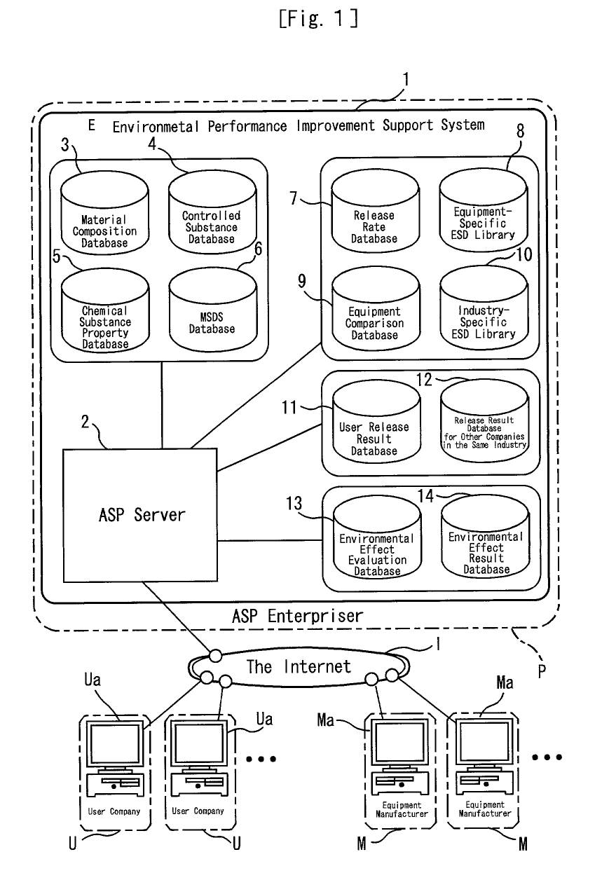

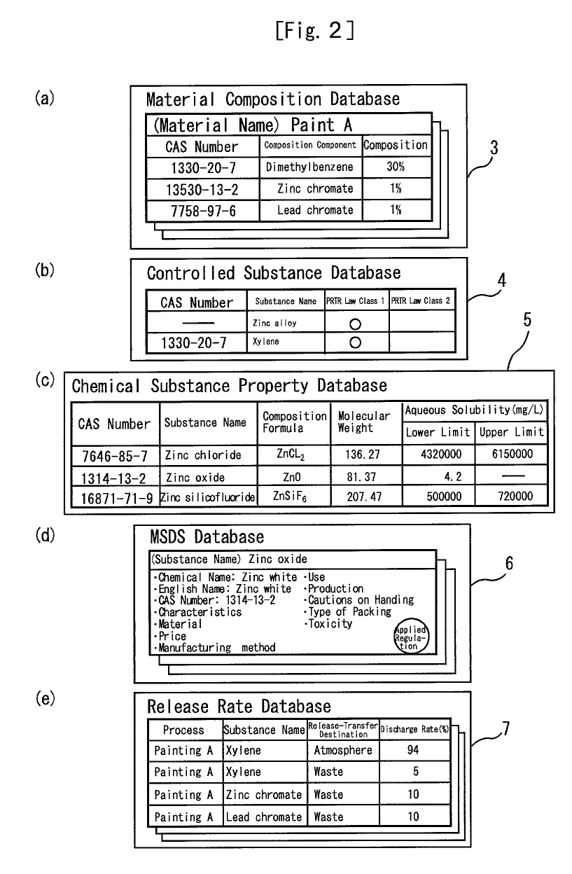

The configuration of environmental performance improvement support system 1 is explained in reference to FIG. 1 and FIG. 2. FIG. 1 is a configuration diagram of the environmental performance improvement support system. FIG. 2 is an example of the data structure of the databases of a portion of FIG. 1, where (a) is the material composition database, (b) is the controlled substances database, (c) is the chemical substance property database, (d) is the MSDS database, and (e) is the release rate database.

Environmental performance improvement support system 1 that is operated by ASP enterpriser P is connected to communication terminals Ua, . . . , of a plurality of user companies U, . . . , and to communication terminals Ma, . . . , of a plurality of equipment manufacturers M, . . . , via the Internet. When information related to the equipments for a manufacturing process, etc., and information on the types and input amounts, etc. of the materials that are input into the equipments is provided from user company U, environmental performance improvement support system 1 provides comparative information on the chemical substances that are released by user company U and another company in the same industry, as well as the environmental performance information and investment effectiveness information to user company U. Also, environmental performance improvement support system 1 is provided with ESD information on each equipment that is used in the manufacturing process, etc., and information on the processing capacities, release rates, operation costs, equipment costs, etc. of the equipments used in the manufacturing process, etc. and treatment equipments for reducing the chemical substances, from equipment manufacturers M, . . .

Because of this, environmental performance improvement support system 1 consists of ASP server 2, material composition database 3, controlled substances database 4, chemical substance property database 5, MSDS [Material Safety Data Sheet] database 6, release rate database 7, equipment-specific ESD library 8, equipment comparison database 9, industry-specific ESD library 10, user release result database 11, release result database on other companies in the same industry 12, environmental effect evaluation database 13, and environmental effect result database 14.

ASP server 2 is explained. ASP server 2 is equipped with a main control unit, storage device, input/output units, communication control unit, etc., all of which are not shown in the figure, and these devices are connected with a bus.

The main control unit comprises an MPU [Micro Processing Unit], RAM [Random Access Memory], etc., and performs general control of environmental performance improvement support system 1. For this, the main control unit is equipped with a WWW [World Wide Web] server program. The WWW server program is a basic communication program for communicating with HTTP [Hyper Text Transfer Protocol]. When ASP server 2 is connected to the Internet I, the WWW server program is loaded into the RAM and executed by the MPU. And, in response to a read request from communication terminal Ua of user company U, the main control unit sends home page data that has been stored in a storage device to communication terminal Ua via the communication control unit, and provides environmental performance improvement support services to user company U. Also, in response to a read request from communication terminal Ma of equipment manufacturer M, the main control unit sends home page data that has been stored in the storage device to communication terminal Ma via the communication control unit, and receives equipment-specific ESD information and investment effectiveness information from equipment manufacturer M.

The storage device comprises a hard disk device, a magneto-optic disk device, etc. The storage device stores home page data, said databases 3, 4, 5, 6, 7, 9, 11, 12, 13, and 14, and said libraries 8 and 10, etc., as well as the environmental performance improvement support program. Also, the input/output units comprise a keyboard, a mouse, a display unit, etc., and are connected via I/O devices. The communication control unit comprises a modem, DSU [Digital Service Unit], etc., and realizes information transmission and reception via the Internet I.

Next, material composition database 3 is explained. A material is usually made up of a plurality of chemical substances. Then, material composition database 3 arranges composition information of materials as a database. Material composition database 3 stores material names, the CAS [Chemical Abstract Services] numbers of the chemical substances that are the composition components, the chemical substance names and the groups of the records with the lower and upper limits fields of the mass compositions (%). A chemical substance has an identifier called the CAS number. In data structure example (a) of FIG. 2, material composition database 3 uses the material names as the key index, and stores the CAS numbers (the identifiers of the composition substances), the names of the composition components, and the mass composition values of the compositions. For the material names, the names as materials in a commercial market or the material numbers when user company U, etc. purchase the materials, etc., are used. Also, as long as a code system assigns in a unique correspondence (1-to-1), any type of nomenclature can be used.

Next, controlled substance database 4 is explained. Controlled substance database 4 arranges chemical substances specified by law as established by the PRTR Law as a database. Also, in addition to those substances, controlled substance database 4 sometimes includes gases based on the Air Pollution Prevention Law, global warming gases, or chemical substances that have serious effects on the environment and chemical substances that must be controlled as chemical substances around that environment, etc., as determined by various groups or enterprisers, as database items. And, controlled substance database 4 stores a group of records that have chemical substance identifiers and the controlling genre (the type, poison, deadly poison, control target, chemical substance specified by law, self-controlled chemical substance, etc., as prescribed by the PRTR Law) as fields. In data structure example (b) of FIG. 2, controlled substance database 4 uses CAS numbers (the identifiers of chemical substances) as the key index, and stores chemical substance names, law and regulation information for chemical substances (especially, the PRTR Law), and also information on the groups, which are not shown in the figure, that specify chemical substances, etc.

Next, chemical substance property database 5 is explained. Chemical substance property database 5 arranges the chemical compounds found among the chemical substances specified by law in controlled substances database 4 as a database. Chemical substance property database 5 stores a group of records that have CAS numbers of chemical substances and their substance property values as fields. The substance property values include coefficients for conversion from molecular masses to the masses of target chemical substances, solubilities into water, vapor pressures, densities, etc. In data structure example (c) of FIG. 2, chemical substance property database 5 uses CAS numbers (the identifiers of chemical substances) as the key index, and stores information of chemical substance names, composition formulas, molecular weights, solubilities into water, coefficients, which are not shown in the figure, for conversion from molecular weights to the masses of target substances, vapor pressures, densities, etc.

Next, MSDS database 6 is explained. MSDS database 6 organizes material handling precautions and toxicity called product safety information, and data that indicates items restricted by law and regulation, as a database for each chemical substance. In data structure example (d) of FIG. 2, MSDS database 6 uses chemical substance names as the key index, and stores product safety information such as chemical names, English names, CAS numbers, characteristics and handling precautions, toxicity, applicable laws and regulations, etc.

Next, release rate database 7 is explained. Release rate database 7 organizes the release rates at each release-transfer destination of each chemical substance that is released from a manufacturing process, etc., (concretely, equipments used in a manufacturing process, etc.) when materials are input into that manufacturing process, etc., as a database. For each manufacturing process, etc., and a combination of materials that are input into that manufacturing process, etc., release rate database 7 stores a group of records that have the weight ratios (namely, the release rates) of the release-transfer chemical substances with respect to the input chemical substances of each release-transfer destination for all the control-requiring chemical substances that are released from that manufacturing process, etc., as fields. For example, if paint A is input into a painting process in a certain production line, data such as 94% of the xylene, which is a component of paint A, is released into the atmosphere is stored. In data structure example (e) of FIG. 2, release rate database 7 uses the names of a manufacturing process, etc., as the key index, and stores the names of chemical substances that are input, release-transfer destinations, and release rates. Although not shown in the figure, materials that are input into a manufacturing process, etc. are also used as a key index.

Also, the data that is stored in release rate database 7 has the weight ratio data of a chemical substance in the release-transfer destinations of that chemical substance as the release rate data for each chemical substance that makes up a material that is input into each process . This release rate data is data that is determined by an equipment that is used in a process in which chemical substances (materials that include the chemical substances) are input. The creation of this data expresses quantitatively the release rate at each release-transfer destination of each chemical substance for each material in each process (each equipment) by investigating for each material that is input into each process (concretely, each equipment that is used in each process). In environmental performance improvement support system 1, information related to the release rates of each equipment (equipment-specific ESD information) is collected from equipment manufacturers M, . . . , and is organized as a database in equipment-specific ESD library 8 and industry-specific ESD library 10. For this, in release rate database 7, release rate data is stored based on equipment-specific ESD library 8 or industry-specific ESD library 10.

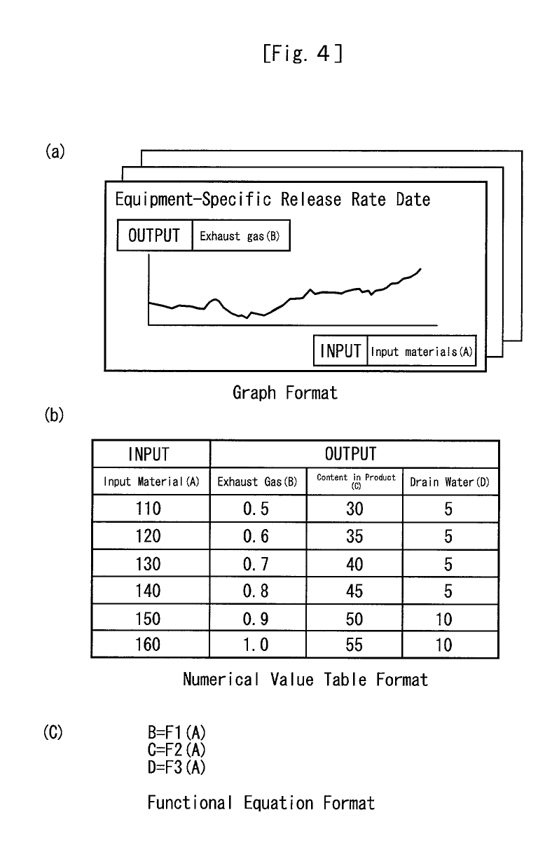

Next, equipment-specific ESD library 8 is explained. Equipment-specific library 8 organizes ESD information for each equipment as a library. This ESD information is the input amounts of the materials that are input into an equipment and the release amount to each release-transfer destination of each chemical substance that is released from that equipment. Concretely, data in graph, numerical value table or function format as shown in FIG. 4, or data in a combination of these formats is organized for each equipment as a library. The data that is organized as a library in equipment-specific ESD library 8 is provided from equipment manufacturers M, . . .

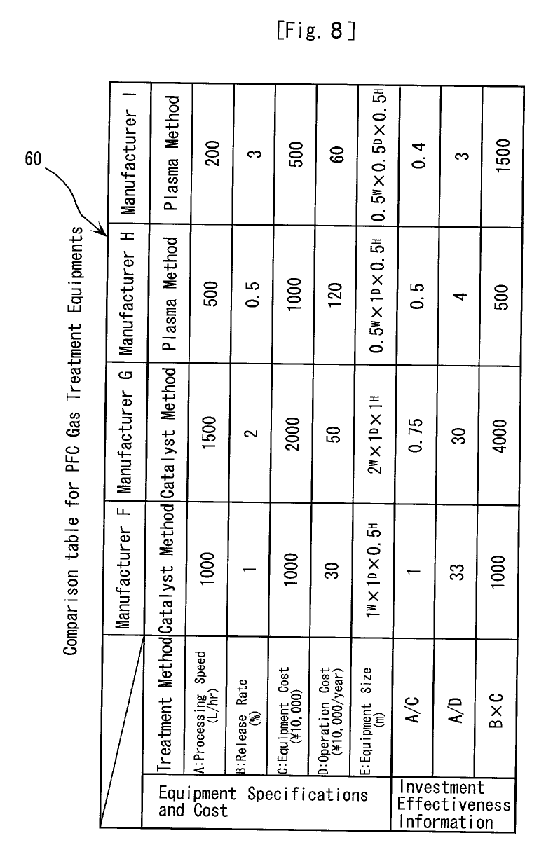

Next, equipment comparison database 9 is explained. Equipment comparison database 9 organizes data that compares the processing capacities (processing speed, release rate, etc.), equipment costs, operation costs, and investment effectiveness information of equipments that are used in a manufacturing process, etc., or treatment equipments that reduce chemical substances, among target equipments, as a database. In case of a treatment equipment for PFC (perfluorocarbon) gas, for example, comparison table 60 shown in FIG. 8 is organized as a database. And, the data except for the investment effectiveness information among the data that is organized as a database in equipment comparison database 9 is provided from equipment manufacturers M, . . .

Next, industry-specific ESD library 10 is explained. Industry-specific library 10 organizes ESD information for each industry as a library. In other words, for representative equipments that are being used in each industry (automobile industry, steel industry, electrical machinery industry, etc.), ESD information is organized as a library, in the same manner as in equipment-specific ESD library 8. So, the data except for the investment effectiveness information among the data that is organized as a library in industry-specific ESD library 10 is provided from equipment manufacturers M, . . .

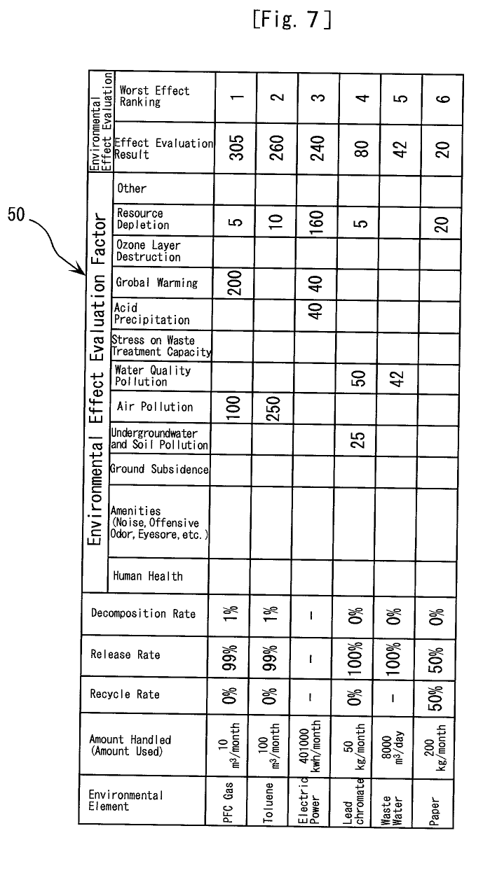

Next, user release result database 11 is explained. User release result database 11 organizes the release rate data of each chemical substance that is derived from information on equipments that are used in a manufacturing process, etc., provided from user companies U, . . . , and the materials that are input into those equipments, as a database, for each user. User release result database 11 uses users, processes (or equipments), and input materials as the key indexes and stores a group of records that have the release rate at each release-transfer destination of each chemical substance as a field. For example, user release result database 11 organizes the release rate data, etc. in evaluation table 50 shown in FIG. 7 as a database.

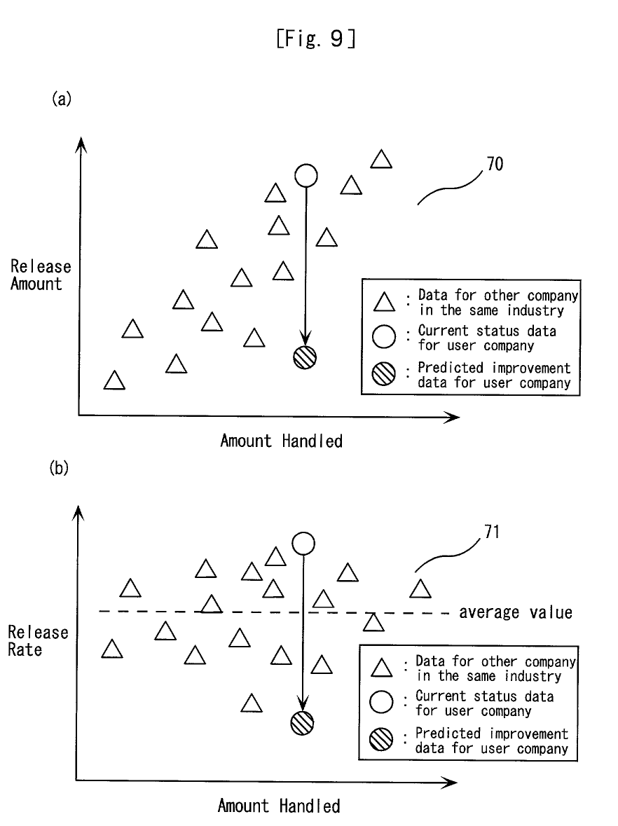

Next, release result database for other companies in the same industry 12 is explained. Release result database for other companies in the same industry 12 organizes data related to handled amounts and release rates of chemical substances (release rates, release amounts, etc.) as a database for each other company in the same industry. Release result database for other companies in the same industry 12 uses company names and chemical substances as the key indexes and stores a group of records that have handled amounts, release rates, and release amounts as fields. As shown in FIG. 9, the data of release result database for other companies in the same industry 12 is used when chemical substance information is compared between a user company and other companies in the same industry. And, release result database for other companies in the same industry 12 is organized by using the data of each enterprise (company) that is accumulated in user release result database 11 and the data that the national and local governments release on chemical substances that are released by each enterprise (company).

Next, environmental effect evaluation database 13 is explained. Environmental effect evaluation database 13 organizes evaluation value conversion tables for obtaining evaluation values of the environmental effect evaluation factors shown in FIG. 7, etc., as a database. Environmental effect evaluation database 13 uses each environmental effect evaluation factor (environmental effect evaluation factor of human health, . . . ) as the key index and organizes the evaluation values corresponding to the release amounts of each chemical substance as a database. For example, in FIG. 7, when the handled amount of PFC gas is 10 m³/month and the release rate is 99%, the air pollution becomes 100. This indicates that based on the evaluation conversion table for air pollution that is stored in environmental effect evaluation database 13, the air pollution evaluation value for the PFC gas release amount (10 m³/month×99%) is 100. This evaluation value is a positive integer, and as it becomes larger, the effect on the environment worsens.

Next, environmental effect result database 14 is explained. Evaluation effect result database 14 organizes the evaluation values of environmental effect evaluation factors that are set corresponding to the release amounts of each chemical substance that are derived from information, provided from user companies U, . . . , on equipments used in a manufacturing process, etc., and the materials that are input into those equipments, and environmental performance information, as a database. Environmental effect result database 14 uses users, manufacturing processes, etc., (or equipments), and the business establishment of user company U, etc., as the key indexes and stores a group of records that have the evaluation value of each environmental effect evaluation factor of each chemical substance and the environmental effect evaluation (environmental performance information) derived from these evaluation values, as fields. For example, environmental effect result database 14 organizes evaluation table 50 shown in FIG. 7 as a database.

Here, communication terminal Ua and communication terminal Ma are briefly explained. Both communication terminals Ua and Ma are terminals that can be connected to the Internet I, and for example, they are personal computers possessed by user company U or equipment manufacturer M. Like ASP server 2, both communication terminals Ua and Ma are equipped with a main control unit, a storage device, input/output units, a communication control unit, etc., as the main components, and these devices are connected by a bus. Furthermore, both communication terminals Ua and Ma are equipped with a WWW browser, and they can view various types of information that are kept for viewing by various servers (WWW servers, etc.) on the Internet. Also, both communication terminals Ua and Ma can send various types of information to various servers on the Internet by using the WWW browsers.

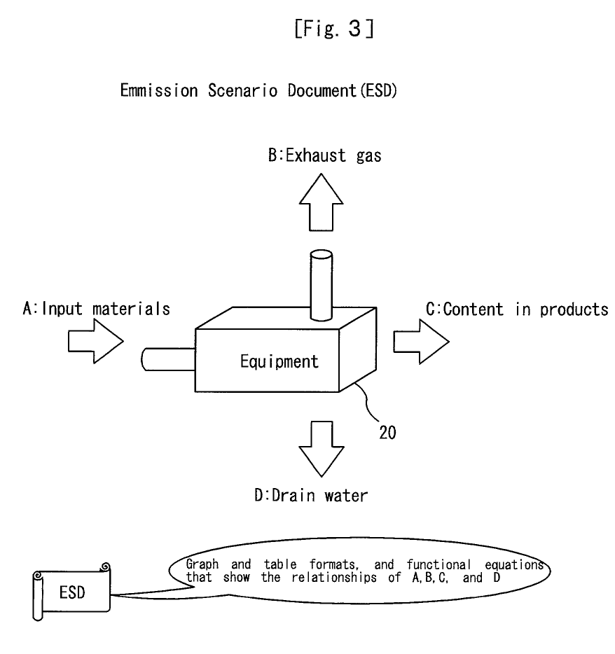

Here, the ESD information which is necessary for setting the release amounts (or release rates) of chemical substances, is explained with reference to FIG. 3 and FIG. 4. FIG. 3 is a conceptual diagram for explaining ESD. FIG. 4 shows concrete examples of the ESD information, where (a) shows a graph format, (b) shows a numerical value table format, and (c) shows a functional equation format.

FIG. 3 shows equipment 20 that is used in a certain manufacturing process. This equipment 20 can be either a single equipment or an equipment that combines a plurality of equipments. The example in FIG. 3 shows that when an input material (A) is input as input into equipment 20, there are exhaust gas (B) released into the atmosphere, content (C) contained in goods produced by equipment 20, and drain water (D) into water areas as the chemical substance releases to each release-transfer destination from equipment 20. Since the amounts of the individual chemical substances that compose that input material (A) are determined once a type and input amount of the input material (A) into equipment 20 are determined, the release amount to each release-transfer destination for the amount of each of those chemical substances is determined by the release characteristics of equipment 20. Accordingly, the ESD is a document that shows input and release relationships that are determined by the characteristics of each equipment, by using a graph format, numerical value table format, or functional equation format for each release-transfer destination of each chemical substance. This ESD information is information that is used for setting release rates of a single equipment, whole unit with combined equipments, or in a manufacturing process.

And, once the type and input amount of the input material (A) into equipment 20 are known, the amount of each chemical substance that compose that input material (A) can be derived. Also, once the input amount of the input material (A) to equipment 20 is known, the release amount to each release-transfer destination of each chemical substance that is released from equipment 20 is known based on the ESD information. Consequently, once equipment 20, and the type and input amount of the input material (A) are known, the release rate of each chemical substance that is released can be derived.

A graph format for the ESD information depicts the relationship of the release amount (OUTPUT) to each release-transfer destination with respect to the input amount (INPUT) of the input material (A) into equipment 20, as a graph. If there are a plurality of chemical substances that are released from equipment 20, a graph is created for each chemical substance. (a) of FIG. 4 shows, for equipment 20, an example in which the relationship of release amounts (OUTPUT) in a release-transfer destination (exhaust gas (B)) with respect to input amounts (INPUT) of the input material (A) is expressed with a graph. Also, for equipment 20, the relationship of the release amounts (OUTPUT) with respect to the input amounts (INPUT) of the input material (A) is also depicted with a graph for the other release-transfer destinations (content in product (C) and drain water (D)), respectively.

The numerical value table format of the ESD information arranges the relationship of the release amount (OUTPUT) to each release-transfer destination with respect to the input amount (INPUT) of the input material (A) into equipment 20 as a numerical value table. If there are a plurality of chemical substances that are released from equipment 20, a numerical value table is created for each chemical substance. (b) of FIG. 4 shows, for equipment 20, an example in which the relationship of the release amounts (OUTPUT) to each release-transfer destination (exhaust gas (B), content in the products (C), and drain water (D)) with respect to the input amounts (INPUT) of the input material (A) is shown.

The functional equation format of the ESD information shows the relationship of the release amounts (OUTPUT) to each release-transfer destination with respect to the input amounts (INPUT) of the input material (A) into equipment 20, with functional equations. If there are a plurality of chemical substances that are released from equipment 20, functional equations are created for each chemical substance. (c) of FIG. 4 shows, for equipment 20, an example, for equipment 20, in which the relationship of the release amounts (OUTPUT) to each release-transfer destination (exhaust gas (B), content in the products (C), and drain water (D)) with respect to the input amounts (INPUT) of the input material (A) is expressed with each functional equation.

The ESD information can be information that shows the characteristics of an equipment when the equipment is used alone, information that shows the characteristics of an equipment when the equipment is used in combination with another equipment, or information that shows the characteristics of an entire equipment group that combines a plurality of equipments. Environmental performance improvement support system 1 stores the ESD information for each equipment in equipment-specific ESD library 8 and the ESD information for each industry in industry-specific ESD library 10.

Below, the processes that are performed by ASP server 2 are explained with concrete examples.

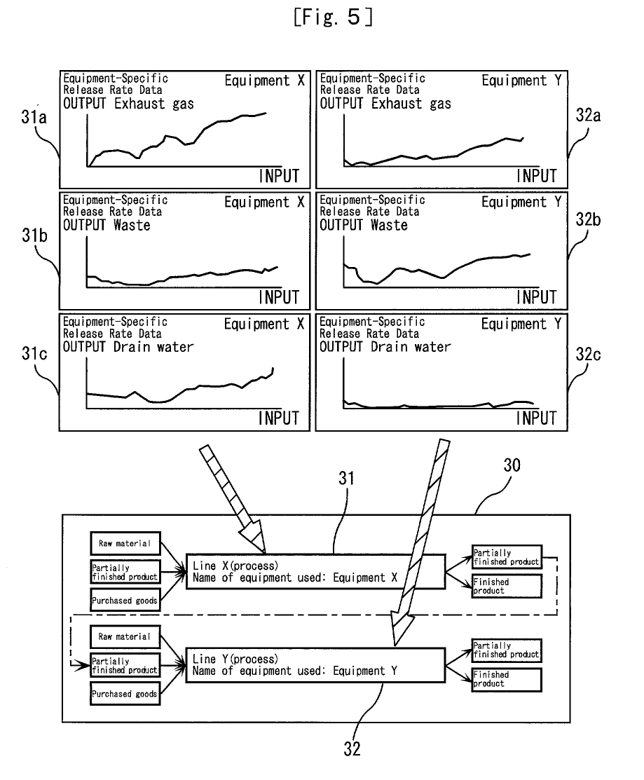

With reference to FIG. 5, the setting process of the release amounts (or release rates) of chemical substances in a manufacturing process is explained. FIG. 5 is a conceptual diagram that shows an example of the relationship between equipment-specific ESD information and a manufacturing process.

FIG. 5 shows manufacturing process 30 that is composed of X line 31 and Y line 32, as an example. In X line 31, equipment X is used; raw materials, partially finished products, and purchased goods as materials are input into equipment X; and partially finished products and finished products are produced. Also, in Y line 32, equipment Y is used; raw materials, purchased goods, and partially finished products produced by X line 31 are input as materials; and partially finished products and finished products are produced. Equipment X releases chemical substances that make up each material that has been input, and the release-transfer destinations include exhaust gas into the atmosphere, content into waste, and drain water into water regions. Also, equipment Y releases chemical substances that make up each material that has been input, and the release-transfer destinations include exhaust gas into the atmosphere, content into waste, and drain water into water regions.

In this way, once an equipment and materials that are input into that equipment are known, the equipment-specific ESD information can be used as described earlier. Then, for equipment X, equipment-specific release rate data 31a, 31b, and 31c are prepared as the equipment-specific ESD information for each release-transfer destination of each chemical substance. Equipment-specific release rate data 31a is data in case of the release-transfer destination is the atmosphere, equipment-specific release rate data 31b is data in case of the release-transfer destination is waste, and equipment-specific release rate data 31c is data in case of the release-transfer destination is water regions. When a plurality of chemical substances are released from equipment X, equipment-specific release rate data 31a, 31b, and 31c are prepared for each chemical substance. Similarly, for equipment Y, equipment-specific release rate data 32a, 32b, and 32c are prepared as the equipment-specific ESD information for each release-transfer destination of each chemical substance. Equipment-specific release rate data 32a is data in case of the release-transfer destination is the atmosphere, equipment-specific release rate data 32b is data in case of the release-transfer destination is waste, and equipment-specific release rate data 32c is data in case of the release-transfer destination is water regions. When a plurality of chemical substances are released from equipment Y, equipment-specific release rate data 32a, 32b , and 32c are prepared for each chemical substance.

Then when the input amounts of the materials to be input into equipment X are known, the release amount to each release-transfer destination of each chemical substance that is released from equipment X can be derived based on equipment-specific release rate data 31a, 31b, and 31c. Also, when the input amounts of the materials to be input into equipment Y are known, the release amount to each release-transfer destination of each chemical substance that is released from equipment Y can be derived based on equipment-specific release rate data 32a, 32b, and 32c. Furthermore, from the derived release amount to each release-transfer destination of each chemical substance, the release amount (or release rate) to each release-transfer destination of each chemical substance that is released from manufacturing process 30 can be derived. And, because the amount of each chemical substance that makes up a material is known from the material input amount, the release rate at each release-transfer destination of a chemical substance can be calculated by dividing the release amount to each release-transfer destination by the chemical substance amount.

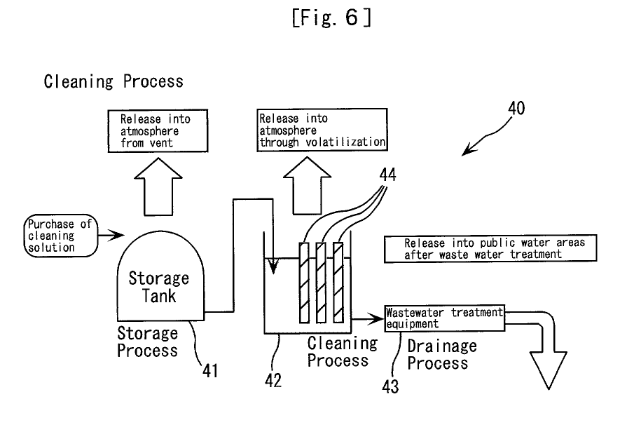

Next, the setting process of each evaluation value of the environmental effect evaluation factors and the environmental effect evaluation (environmental performance information) that are derived from the release amounts (or release rates) of chemical substances is explained with reference to FIG. 6 and FIG. 7. FIG. 6 is an example of a process diagram for a cleaning process that is performed by a user company. FIG. 7 is an evaluation table that shows an example of the environmental effect evaluation results in the user company that performs the cleaning process of FIG. 6.

FIG. 6 shows cleaning process 40 that consists of a storage process, a cleaning process, and a drainage process at user company U, as an example. In the storage process, storage tank 41 (equivalent to an equipment) is used, and a cleaning solution (equivalent to a material) is input and stored in this storage tank 41. In the cleaning process, cleaning equipment 42 is used, the cleaning solution is input from storage tank 41 into this cleaning equipment 42, and products 44 are washed. In the drainage process, wastewater treatment equipment 43 is used, the wastewater in cleaning equipment 42 is input into this wastewater treatment equipment 43, and the wastewater is treated. In storage tank 41, chemical substances that make up the cleaning solution that has been input are released from a vent, and the release-transfer destination is exhaust gas into the atmosphere. In cleaning equipment 42, chemical substances that make up the cleaning solution that has been input are released by volatilization, and the release-transfer destination is exhaust gas into the atmosphere. In wastewater treatment equipment 43, the wastewater that has been input is treated and then drained into water regions.

And, concerning the chemical substances that are released from cleaning process 40, it is known by using equipment-specific ESD library 8 that PFC gas and toluene are released into the atmosphere by said setting process. Furthermore, according to the input amount of the cleaning solution that is input in cleaning process 40, the release amounts (release rates) of the PFC gas and toluene by said setting process can be derived by using equipment-specific ESD library 8. And, the results on the release amounts (release rates) of these chemical substances are stored in user release result database 11.

First, as shown in evaluation table 50 of FIG. 7, as the environmental elements, user company U that has this cleaning process 40 releases PFC gas, toluene, and lead chromate, which are chemical substances, as well as power consumption, which is not released directly as a chemical substance, drain water into wastewater, and paper consumption. Since power consumption, etc., affect the environment directly or indirectly, they are set as evaluation targets even if they do not release chemical substances directly. For example, in the case of power consumption, it affects the environment because petroleum is consumed, and also, carbon dioxide, etc. are generated when generating power. And, handled amounts, recycle rates, release rates, and decomposition rates of PFC gas, toluene, etc., are set, and the release amounts to each release-transfer destination are known from these values.

As described earlier, once the release amounts to each release-transfer destination of the PFC gas, toluene, etc. are known, the individual evaluation values of the environmental effect evaluation factors can be set based on environmental effect evaluation database 13. As described earlier, these evaluation values are positive integers, and the larger the values, the worse the effects on the environment. Evaluation table 50 in FIG. 7 shows that in the case of PFC gas, for the release amount of 10 m³/month×99%, the evaluation value of the environmental effect evaluation factor of air pollution is 100, the evaluation value of the environmental effect evaluation factor of global warming is 200, the evaluation value of the environmental effect evaluation factor of resource depletion is 5, and there is no adverse effect for the other environmental effect evaluation factors.

Furthermore, to evaluate effects on the environment comprehensively, for each environmental element, all the evaluation values of the environmental effect evaluation factors are added and it is indicated as the effect evaluation result. This effect evaluation result is also a positive integer, and the larger the value, the worse the effect on the environment. For example, the effect evaluation value of PFC gas is 305 by adding the evaluation values 100, 200, and 5. As can be known from evaluation table 50 of FIG. 7, for user company U that has cleaning process 40, PFC gas and toluene, which are released from this cleaning process 40, have a large effect on the environment and are the worst (305) and the second worst (260), respectively. Then, for this user company U, starting from improving the release amount of PFC gas, which is the worst one, can be determined as a policy. This policy can be determined by ASP server 2, or user company U can determine the policy by providing the data of this evaluation table 50 to user company U.

Next, the process for calculating investment effect information of treatment equipments to reduce PFC gas and the process for selecting a treatment equipment are explained, with reference to FIG. 8. FIG. 8 is a comparison table that shows an example of the evaluation comparison results for PFC gas treatment equipments.

Here, the case of released PFC gas is processed and its release amount is reduced by introducing a PFC gas treatment equipment is explained. In addition, there is the case of the release amount itself of PFC gas that is released from an equipment is reduced by replacing storage tank 41 or cleaning equipment 42 (see FIG. 6) that releases PFC gas.

Comparison table 60 shown in FIG. 8 lists the data of PFC gas treatment equipments that are registered in equipment-specific ESD library 8 and the investment effect information that is calculated from that data, and is registered to equipment comparison database 9. The data other than the investment effect information in the data of this comparison table 60 is provided by equipment manufacturers M ,. . . In this comparison table 60, PFC gas treating methods, amounts of PFC gas that can be treated per unit time (A), post-treating release rates (B), equipment costs (C), operations costs (D) such as an electric power fee, etc., and equipment sizes are registered separately for each treatment equipment (manufacturer), as the basic information (equipment specifications and cost information) of the treatment equipments.

Furthermore, to make comparison of treatment equipments easy, investment effect information that clarifies the cost performance of each equipment is registered to this comparison table 60. As shown in comparison table 60, A/C, A/D, and B×C are calculated as this investment effect information. Because A/C is the ratio of a processing speed with respect to an equipment cost, this information indicates the larger this value, the higher cost performance the equipment has. Because A/D is the ratio of a processing speed with respect to an operation cost, this information indicates the larger the value, the higher cost performance the equipment has. Because B×C is the product of a release rate and an equipment cost, this information indicates the smaller this value, the higher cost performance the equipment has.

And, a PFC gas treatment equipment is selected based on the investment effect information of this comparison table 60. Although, this selection is performed by user company U, it can also be performed by an ASP server. The selection of the treatment equipment to be installed in user company U, which has the evaluation results shown in FIG. 7, is concretely explained. As is known from comparison table 60, the device that has the smallest B×C value is the treatment equipment of manufacturer H that uses a plasma method, and the cost performance with respect to the release rate is high. On the other hand, the equipment that has the largest A/C and A/D values is the treatment equipment of manufacturer F that uses a catalyst method, and the cost performance with respect to the processing speed is high. Therefore the selection is narrowed to the treatment equipments of manufacturers F and H.

Furthermore, the required performance as a PFC gas treatment equipment is pointed out from the conditions at user company U. As is known from evaluation table 50 of FIG. 7., the PFC gas release amount of user company U is 10 m³/month×99%, which when converted this to an amount per operation hour is approximately 14000 L/hr, which is a large amount. In other words, it is known that user company U needs a PFC gas treatment equipment that has a superior processing performance (processing speed). Therefore, for user company U, it can be judged that selecting the PFC gas treatment equipment of manufacturer F, which has a high cost performance for processing speed, is the best choice. At this time, if all of the PFC gas is to be treated, it can be also derived that an expenditure of 140 million yen is necessary as the equipment cost because 14 units (14000/1000) of the PFC gas treatment equipment of manufacturer F will be necessary.

Next, the process that shows a degree of environmental performance improvement when a PFC gas treatment equipment is installed is explained, with reference to FIG. 9. FIG. 9 shows comparison diagrams that compare PFC gas-related information for a user company and for other companies in the same industry, when a PFC gas treatment equipment is installed; where (a) is a comparison diagram based on PFC gas handled amounts and release amounts, and (b) is a comparison diagram based on PFC gas handled amounts and release rates.

Here, the case that user company U, which has the evaluation results shown in FIG. 7, is planning to install PFC gas treatment equipments of manufacturer F is concretely explained. Since paying 140 million yen at one time is a large investment amount for user company U, it is assumed that user company U plans to install seven units, as half of the required number, as the first step to ascertain the introduction effect of the PFC gas treatment equipments.

First, by said setting process, the release amounts of PFC gas that is released from cleaning process 40 are each set by using equipment-specific ESD library 8. Furthermore, it is assumed that seven units of the PFC gas treatment equipment are placed at locations where PFC gas is released in this cleaning process 40, according to the release amounts. And, a simulation for the assumed case is performed by using the processing speed, release rate, etc., for the PFC gas treatment equipment in comparison table 60 of FIG. 8, and the evaluation is performed.

From this simulation, the release amounts and release rates for handled amounts of PFC gas are derived for the case that seven units of the PFC gas treatment equipment are installed. And, numerical value tables (not shown) and comparison diagrams (not shown) for the release amounts and release rates for handled amounts of PFC gas when the equipments are installed and the current release amounts and release rates for handled amounts of PFC gas are created. Furthermore, comparison diagrams 70 and 71 of the release amounts and release rates for handled amounts of PFC gas for user company U and other companies in the same industry are created for comparing implementations on the environment with other companies in the same industry. These comparison diagrams 70 and 71 show the current data and simulation-based expected improvement data of user company U that used data from user release result database 11 as the release amounts and release rates for the handled amounts of PFC gas. Furthermore, these comparison diagrams 70 and 71 also show the data of other companies in the same industry that used data from release result database for other companies in the same industry 12 as the release amounts and release rates for the handled amounts of PFC gas.

In this way, by comparing the data with data for other companies in the same industry, using comparison diagrams 70 and 71, user company U can find out that although both the release amounts and release rates for the current data are at a high level compared with those of other companies, they can be reduced to a low level compared with those of other companies in the expected improvement data. Therefore, it is known that installing seven units of the PFC gas treatment equipment as the first stage is effective in improving the environmental performance.

Also, for example, when explaining to residents who live around the business establishment of user company U (risk communication), comparison diagrams 70 and 71 like this become an extremely effective means because the company can appeal to the fact that, based on the expected improvement data, the release rate (release amount) of the company is below the average in the industry.

Furthermore, a simulation similar to the previous simulation can be performed also when another seven units of the PFC gas treatment equipment are installed in the second phase. And, numerical value tables (not shown) and comparison diagrams (not shown) of the release amounts and release rates for handled amounts of PFC gas when the equipment units of the second phase are installed and the release amounts and release rates for handled amounts of PFC gas in the first stage are created, and also comparison diagrams (not shown) of the release amounts and release rates for handled amounts of PFC gas for user company U and other companies in the same industry are created for comparison of implementations on the environment with other companies in the same industry. Furthermore, numerical value tables (not shown) and comparison diagrams (not shown) that show time-lapse changes in the release amounts and release rates for handled amounts of PFC gas in the current situation, when the equipment units of the first phase are installed, and when the equipment units of the second phase are installed are created, including data for other companies in the same industry.

Furthermore, by showing the time-lapse improvement data for such chemical substances to residents who live around the business establishment of user company U, the position of user company U on dealing with the environment can be shown, and it becomes easy to obtain the understanding of the residents.

By the processings shown above, ASP server 2 can provide information including the release amounts of chemical substances in a manufacturing process, etc., the individual evaluation values of environmental effect evaluation factors and the environmental effect evaluation (environmental performance information), comparison and investment effect information of treatment equipments, the result of a treatment equipment selection, and the degree of environmental performance improvement resulting from a treatment equipment installation, etc., to user companies U, . . . , via the Internet. In the presentation, the information is sent as files or displayed on the monitor of communication terminal Ua. Also, the information is sometimes sent offline by printing it out on paper and mailing it.

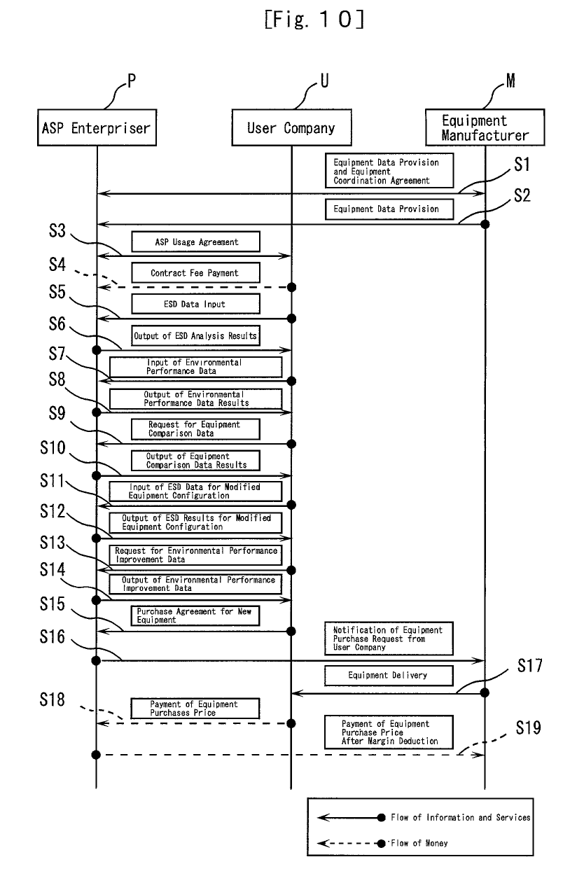

With reference to FIG. 1 or FIG. 9, an example of the flow of information, service, and money among ASP enterpriser P, user company U, and equipment manufacturer M in environmental performance improvement support system 1 is explained in accordance with the flow diagram of FIG. 10. FIG. 10 is a flow diagram that shows the flow of information, service, and money among an ASP enterpriser (environmental performance improvement support system), user company, and equipment manufacturer.

First, ASP enterpriser P concludes the agreement for provision of equipment-related data, such as equipments to be used in user company U and treatment equipments for chemical substances, etc., and coordination for the purchase of those equipments by user company U, with equipment manufacturer M (S1). This contracting can be carried out with environmental performance improvement support system 1 and communication terminal Ma via the Internet I, or with representatives of ASP enterpriser P and equipment manufacturer M. After this contracting, equipment manufacturer M provides equipment-related data from communication terminal Ma to environmental performance improvement support system 1, via the Internet I (S2).

Also, responding to a request from user company U, ASP enterpriser P concludes the agreement for services by environmental performance improvement support system 1, with user company U (S3). This contracting can be carried out with environmental performance improvement support system 1 and communication terminal Ua via the Internet I, or with representatives of ASP enterpriser P and user company U. After this contracting, user company U pays a contract fee to ASP enterpriser P (S4). Furthermore, user company U pays a service offer fee each time a service is provided or each month, etc.

And, if information related to the release of chemical substances from a manufacturing system newly to be operated (or currently operating) is necessary, user company U connects from communication terminal Ua to ASP server 2 via the Internet I, and sends information related to an equipment in that manufacturing system (type, manufacturer, etc.) and information related to the materials that are input into that equipment (type, input amounts, etc.) (S5). Whereupon, based on equipment-specific ESD library 8, ASP server 2 derives information on the release amounts to each release-transfer destination of each chemical substance that is released from that equipment (manufacturing system), according to the equipment-related information and information related to the input materials that were sent, and sends that information to communication terminal Ua (S6).

Next, if environmental performance information on the entire business establishment that possesses said manufacturing system is necessary, user company U sends information (information related to electric power at the business establishment, information related to wastewater, etc.) necessary for deriving environmental performance information, other than the information that was previously sent, from communication terminal Ua to ASP server 2 (S7). Whereupon, based on environmental effect evaluation database 13, ASP server 2 derives the evaluation values of the environmental effect evaluation factors for each chemical substance, electric power, etc., and also derives the effect evaluation results and the worst effect rankings, and sends these evaluation results to communication terminal Ua (S8).

Furthermore, if information related to an equipment that reduces the chemical substance ranked as the worst one is necessary, user company U requests from communication terminal Ua for ASP server 2 to provide equipment comparison data (S9). Whereupon, if the equipment comparison data has been already registered to equipment comparison database 9, ASP server 2 sends the equipment comparison data to communication terminal Ua, or if the equipment comparison data has not been registered to equipment comparison database 9, ASP server 2 creates equipment comparison data based on equipment-specific ESD library 8, and sends the created equipment comparison data to communication terminal Ua (S10).

And, based on the equipment comparison data that was sent, if user company U decides to replace equipments in the manufacturing system, it sends information related to those equipments (equipment manufacturer, model, number of units, etc.) to ASP server 2; or if the company decides to install treatment equipments for chemical substances, it sends information related to those treatment equipments (equipment manufacturer, model, number of units, etc.) to ASP server 2 (S11). Whereupon, based on the information related to the equipments or the information related to the treatment equipments, ASP server 2 derives the release amounts to each release-transfer destination of chemical substances in the case of the equipments in the manufacturing system are replaced or when the treatment equipments are introduced, and sends that information to communication terminal Ua (S12).

Furthermore, if improvement information in the case of the equipments in the manufacturing system are replaced or the treatment equipments are introduced, and comparison information with other companies in the same industry (for example, the comparison diagrams like those shown in FIG. 9) are necessary, user company U requests ASP server 2 to provide those information (S13). Whereupon, based on release result database for other companies in the same industry 12, etc., ASP server 2 derives the improvement information and comparison information, and sends those information to communication terminal Ua (S14).

And, based on the information that has been sent from ASP server 2, user company U determines the equipments to be replaced in the manufacturing system or the chemical substance treatment equipments to be introduced, inputs necessary items (equipment manufacturer, model, number of units, etc.) on the equipment purchase agreement screen (not shown) that is provided by ASP server 2, and makes a purchase agreement (S15). Whereupon, ASP enterpriser P connects from ASP server 2 to communication terminal Ma of equipment manufacturer M of the equipments specified in the purchase agreement via the Internet 1, and sends that information on the purchase agreement (S16).

And, based on that purchase agreement, equipment manufacturer M delivers the equipments to user company U (S17). When the equipments have been delivered, user company U pays the purchase cost for those equipments to ASP enterpriser P (S18). Then, ASP enterpriser P deducts the coordination fee for the equipments from that purchase cost and pays the purchase cost of the equipments after the deduction to equipment manufacturer M (S19).

According to this environmental performance improvement support system 1, since the release amounts to each release-transfer destination of the chemical substances that are released from the manufacturing process, etc., are derived based on the ESD information for each equipment that releases chemical substances, the accuracy of the release-related information of those chemical substances is good, and information related to the chemical substances that are released from a manufacturing process, etc., that combines a plurality of equipments can be derived easily, too. Furthermore, this environmental performance improvement support system 1 can easily derive the evaluation values of environmental effect evaluation factors according to the release amounts of chemical substances, based on environmental effect evaluation database 13, and in turn, it can easily derive the environmental performance information such as the effect evaluation results, etc., from these evaluation values of the environmental effect evaluation factors. And, since chemical substances that have large effects on the environment can be identified from this environmental performance information, chemical substances that require reduction measures in the manufacturing process, etc., can be identified easily. Also, since this environmental performance improvement support system 1 derives investment effect information for equipments that reduce chemical substances, the quality of an equipment that reduces a chemical substance can be judged from a cost performance aspect. In other words, this environmental performance improvement support system 1 can provide information on the environmental effect degree of each chemical substance from the manufacturing process, etc., and information for reducing the release amounts of chemical substances from the manufacturing process, etc. As a result, the environmental performance improves because user company U can easily grasp the effects that the chemical substances that are released have on the environment and obtain motivation for introducing equipments that reduce chemical substances.

Furthermore, according to this environmental performance improvement support system 1, effects on the environment can be predicted from various aspects, and the accuracy of the environmental performance information is high because the environmental performance information is derived based on environmental effect evaluation factors, such as human health, amenities (noise, offensive odors, eyesores, etc.), ground subsidence, underground water pollution and soil pollution, air pollution, water quality pollution, stress on waste treatment capacity, acid precipitation, global warming, ozone layer destruction, and/or resource depletion, etc. Also, according to this environmental performance improvement support system 1, the quality of an equipment can be judged with high accuracy because investment effect information is derived from the processing performance, equipment cost, operation cost, etc. of the equipment.

Also, according to this environmental performance improvement support system 1, ESD information is easy to handle because the ESD information is expressed as information that is represented in graph format, numerical value table format, or with functional equations, or as information that is represented as a combination of these formats.

Furthermore, according to this environmental performance improvement support system 1, data comparison with information for user company U can be performed easily because release result database for other companies in the same industry 12 has information such as the handled amount, release amount, and release rate or recycle rate of each chemical substance for other companies in the same industry. Also, according to this environmental performance improvement support system 1, the current data (or past data) and the predicted improvement data when equipments for reducing chemical substances are introduced to user company U can be compared because user release result database 11 contains time-lapse change information on information such as the handled amounts, release amounts, and release rates or recycle rates of each chemical substance for user company U. Furthermore, according to this environmental performance improvement support system 1, comparison with the time-lapse change information of user company U can be performed easily because release result database for other companies in the same industry 12 contains time-lapse change information on information such as the handled amounts, release amounts, and release rates or recycle rates of each chemical substance for other companies in the same industry. As a result of that, user company U can plan risk communication because it can show reduction data on chemical substances that are released and comparison data with other companies in the same industry to the residents around the business establishment.

Also, with this environmental performance improvement support system 1, accurate information can be obtained by having equipment manufacturer M provide equipment-specific ESD information, and information collection is also easy. Also, with this environmental performance improvement support system 1, accurate information can be obtained by having manufacturer M provide information such as the processing performances, equipment costs, and operation costs, etc. of equipments that reduce chemical substances, and information collection is also easy.

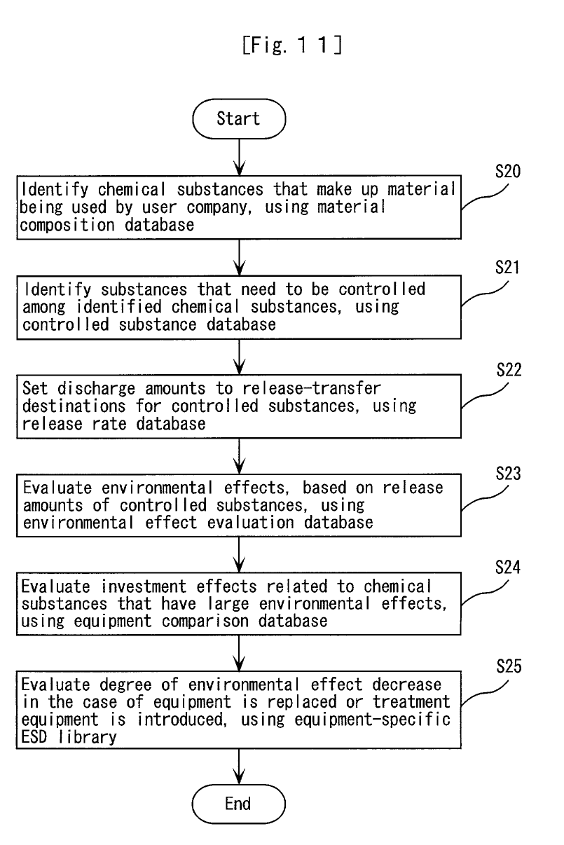

Finally, the environmental performance improvement support method of environmental performance improvement support system 1 is explained in accordance with the flow chart of FIG. 11, with reference to FIG. 1 or FIG. 10. FIG. 11 is a flow chart that shows the environmental performance improvement support method.

With environmental performance improvement support system 1, ASP server 2 carries out the processes described below when information related to equipments that are used in a manufacturing process, etc., and information related to the materials that are input into those equipments are sent from user company U.

First, based on material composition database 3, ASP server 2 identifies the chemical substances that compose the materials that are input (S20).

In present preferred embodiment, the process of S20 corresponds to process 1 that is described in What Is Claimed Is.

And, based on controlled substance database 4, ASP server 2 identifies the chemical substances that must be managed from among the identified chemical substances (S21).

In present preferred embodiment, the process of S21 corresponds to process 2 that is described in What Is Claimed Is.

Furthermore, based on release rate database 7, ASP server 2 sets the release amounts to each release-transfer destination of the chemical substances that must be managed (S22). If the necessary information has not yet been stored in release rate database 7, ASP server 2 derives the release amounts to each release-transfer destination of each chemical substance that is released according to the input amounts of the materials that are input, based on equipment-specific library 8. And, based on the information that was derived, ASP server 2 stores the release rate data to release rate database 7.

In present preferred embodiment, the process of S22 corresponds to process 3 that is described in What Is Claimed Is.

Next, based on environmental effect evaluation database 13, ASP server 2 sets individually the evaluation values of each environmental effect evaluation factor of the chemical substances and furthermore, based on these evaluation values, sets the environmental effect evaluation results and the worst effect ranking (environmental performance information) of the chemical substances (S23).

In present preferred embodiment, the process of S23 corresponds to process 4 that is described in What Is Claimed Is.

Furthermore, for the chemical substances (the chemical substance ranked as the worst one, etc.) that, based on the environmental effect evaluation results, are judged to have large effects on the environment, ASP server 2 creates comparison data on investment effect information for each equipment that reduces these chemical substances, based on equipment comparison database 9 (S24). If the necessary information has not yet been stored in equipment comparison database 9, ASP server 2 derives individually the investment effect information from the processing performances, release rates, operation costs, and equipment costs of each equipment, based on equipment-specific library 8. And, ASP server 2 stores the information that was derived to equipment comparison database 9.

In present preferred embodiment, the process of S24 corresponds to process 5 that is described in What Is Claimed Is.

Finally, based on the equipment-specific library 8, ASP server 2 sets the release amounts to each release-transfer destination of chemical substances in the case of equipments that reduce the chemical substances, as determined based on investment effect information, are introduced. And, to clarify the extents to which the release amounts were reduced by the equipments introduction, ASP server 2 creates comparison information between the release amounts that were set and the current release amounts to each release-transfer destination of the chemical substances (S25). Furthermore, based on release result database for other companies in the same industry 12, ASP server 2 creates comparison information between these release amounts that were set and the release amounts of other companies in the same industry (S25).

In present preferred embodiment, the process of S25 corresponds to process 6 that is described in What Is Claimed Is.

In addition, the ASP server stores information that was input, information that was set, information that was created, etc., into databases 3, 4, 5, 6, 7, 9, 11, 12, 13, and 14, as necessary. Also, ASP server 2 outputs information that was input, information that was set, information that was created, etc., on a screen, in a voice, on paper, or via the Internet, as necessary.

According to this environmental performance improvement support method, environmental performance information for each chemical substance that requires management can be set by identifying the chemical substances that require management from among the chemical substances that make up the materials that are input into a manufacturing system, etc., and by setting the release amounts to each release-transfer destination of those chemical substances that require management. As a result of that, determining the policy to be taken to reduce adverse effects on the environment is simplified, and the environmental performance can be improved because the chemical substances that have large effects on the environment can be identified by this environmental performance information.

Furthermore, according to this environmental performance improvement support method, the equipment selection criteria are clarified and the most suitable equipment can be selected because each equipment for reducing chemical substances can be evaluated based on investment effect information.

Moreover, according to this environmental performance improvement support method, the investment effect when equipments are introduced becomes clearer and becomes the motivation for deciding on equipments because the effect degree on the environment in the case of equipments that reduce chemical substances are introduced can be evaluated. Also, by presenting the effect degree on the environment like this to the surrounding residents, risk communication with the surrounding residents can be planned, and understanding on the undertaking for the environment is easily obtained.

Although the aforementioned explains the preferred embodiment of the present invention, the present invention is not limited to said preferred embodiment and is implemented through various embodiments.

For example, although the present preferred embodiment is configured so that an ASP enterpriser provides services from the environmental performance improvement support system via a communication circuit, such as the Internet, it can also be configured so that the environmental performance improvement support system is installed at a user company, etc.

Also, although the present preferred environment is configured so that an ASP enterpriser, user company and equipment manufacturer are connected via the Internet, other communication circuits, such as an exclusive circuit, etc., can also be used.

According to the present invention, effects on the environment due to release of chemical substances are evaluated, and furthermore improvement of the environmental performance can be supported.

What is claimed is:

1. An environmental performance improvement support system, comprising:
a material composition database that organizes composition information of materials as a database;
a controlled substance database that organizes control information related to chemical substances as a control target, as a database; and
a release rate database that organizes information related to the release rates at each release-transfer destination of chemical substances as a database, wherein:
based on the types and input amounts of the materials that are input in a certain process, the release amounts to each release-transfer destination of chemical substances that compose said materials are set;
information for improving the environmental performance, according to information on these chemical substances that are released is set;
the information related to said release rates is set based on the release information that prescribes the relationship of the release amounts to each release-transfer destination of the chemical substances with respect to the input amounts of the materials that are input into equipments that are used in said certain process; and
environmental performance information that evaluates environmental effects due to discharging chemical substances in the release amounts that correspond to the input amounts of said materials that are input, and/or investment effectiveness information related to the costs for reducing said chemical substances that are released are set.

2. The environmental performance improvement support system recited in claim 1, wherein:
said environmental performance information is information that evaluates environmental effects based on at least one impact factor from among impact factors on human health, impact factors on amenities, impact factors on ground subsidence, impact factors on ground water pollution and soil pollution, impact factors on air pollution, impact factors on water quality pollution, impact factors on stress on waste treatment capacity, impact factors on acid precipitation, impact factors on global warming, impact factors on ozone layer destruction, and impact factors on resource depletion.

3. The environmental performance improvement support system recited in claim 1, wherein:
said investment effectiveness information is information that is set based on at least one item from among the processing performances, equipment costs, and operation costs of equipments that reduce said chemical substances that are released.

4. The environmental performance improvement support system recited in one of the claims from claim 1 to claim 3, wherein:
the equipments used in said certain process consists of a combination of a plurality of equipments; and
said environmental performance information and/or said investment effectiveness information are information that are set based on the combination of said plurality of equipments.

5. The environmental performance improvement support system recited in one of the claims from claim 1 to claim 3, wherein:
said release information is information that is represented in graph format, table format, or with functional equations, or is information that is represented by a combination of these formats for each equipment that is used in said certain process.

6. An environmental performance improvement support system, comprising:
a material composition database that organizes composition information of materials as a database;
a controlled substance database that organizes control information related to chemical substances as a control target, as a database; and
a release rate database that organizes information related to the release rates at each release-transfer destination of chemical substances as a database, wherein:
based on the types and input amounts of the materials that are input in a certain process, the release amounts to each release-transfer destination of chemical substances that compose said materials are set;
information related to an enterpriser that performs said certain process is output;
at least one information type from among the handled amount, release amount, release rate, and recycle rate of each chemical substance is available as information related to the release rates of another enterpriser in the same industry; and
information that compares information related to the release rates of said enterpriser and said other enterpriser in the same industry is output.

7. An environmental performance improvement support system, comprising:
a material composition database that organizes composition information of materials as a database;
a controlled substance database that organizes control information related to chemical substances as a control target, as a database; and
a release rate database that organizes information related to the release rates at each release-transfer destination of chemical substances as a database, wherein:
based on the types and input amounts of the materials that are input in a certain process, the release amounts to each release-transfer destination of chemical substances that compose said materials are set;
information related to an enterpriser that performs said certain process is output; and
time-lapse changes of at least one information type from among the handled amount, release amount, release rate, and recycle rate of each chemical substance are output as information related to the release rates of said enterprises.

8. An environmental performance improvement support system, comprising:
a material composition database that organizes composition information of materials as a database;
a controlled substance database that organizes control information related to chemical substances as a control target, as a database; and
a release rate database that organizes information related to the release rates at each release-transfer destination of chemical substances as a database, wherein:
based on the types and input amounts of the materials that are input in a certain process, the release amounts to each release-transfer destination of chemical substances that compose said materials are set;
information related to an enterpriser that performs said certain process is output;
information of time-lapse changes of at least one from among the handled amount, release amount, release rate, and recycle rate of each chemical substance, of another enterpriser in the same industry is available; and
information that compares time-lapse changes of at least one from among the handled amount, release amount, release rate, and recycle rate of each chemical substance between said enterpriser and said other enterpriser in the same industry is output.

9. An environmental performance improvement support system, comprising:
a material composition database that organizes composition information of materials as a database;
a controlled substance database that organizes control information related to chemical substances as a control target, as a database; and
a release rate database that organizes information related to the release rates at each release-transfer destination of chemical substances as a database, wherein:
based on the types and input amounts of the materials that are input in a certain process, the release amounts to each release-transfer destination of chemical substances that compose said materials are set;
information for improving the environmental performance, according to information on these chemical substances that are released, is set;
information related to said release rates is set based on the equipment-specific release rate information that is provided by the enterprisers that manufacture equipments which are used in said certain process; and
environmental performance information that evaluates environmental effects due to discharging chemical substances in the release amounts that correspond to the input amounts of said materials that are input, and/or investment effectiveness information related to the costs for reducing said chemical substances that are released are set.

10. The environmental performance improvement support system recited in claim 9, wherein:
said investment effectiveness information is information that is set based on at least one item from among the processing performances, equipment costs, and operation costs of equipments that reduce chemical substances, which are provided by the enterprisers that manufacture the equipments which reduce the chemical substances.

11. The environmental performance improvement support system recited in claim 9 or claim 10, wherein:
the equipment-specific release rate information provided by said enterprisers is release information that prescribes the relationship of the release amounts to each release-transfer destination of chemical substances that correspond to the input amounts of the materials that are input into equipments.

12. An environmental performance improvement support method, wherein:
environmental performance improvement is supported based on a material composition database that organizes composition information of materials as a database, a controlled substance database that organizes control information related to chemical substances as a control target as a database, and a release rate database that organizes information related to the release rates at each release-transfer destination of chemical substances as a database, comprising:
process 1, which, based on said material composition database, identifies the chemical substances that compose the materials to be input in a certain process;
process 2, which, based on said controlled substance database, identifies the chemical substances that must be managed from among the chemical substances identified in said process 1;
process 3, which, based on said release rate database, sets the release amounts to the release-transfer destinations of the chemical substances identified in said process 2; and
process 4, which evaluates environmental effects due to discharging the chemical substances in the release amounts set in said process 3.

13. The environmental performance improvement support method recited in claim 12, comprising:
process 5, which, based on the evaluation results of said process 4, evaluates the equipments that reduce said chemical substances which are released.

14. The environmental performance improvement support method recited in claim 13, comprising:
process 6, which, based on the evaluation results of said process 5, evaluates environmental effects in the case of equipments that reduce said chemical substances are installed.
